(19) United States
(12) Patent Application Publication
(10) Pub. No.: US 2026/0252634 A1
(43) Pub. Date: Aug. 27, 2026

(54) AUTOMATICALLY TAGGING WEB CONTENT WITH TOPIC TAGS UTILIZING A SEMANTIC TOPIC MODEL

(71) Applicant: Qualtrics, LLC, Provo, UT (US)

(72) Inventor: Raymond Gerber, Inlet Beach, FL (US)

(21) Appl. No.: 19/062,958

(22) Filed: Feb. 25, 2025

(51) Int. Cl. G06F 16/93; G06N 3/045

(52) U.S. Cl. CPC G06F 16/93; G06N 3/045

(57) ABSTRACT

The present disclosure relates to systems, non-transitory computer-readable media, and methods for utilizing a semantic topic model in combination with one or more neural networks to embed generated topic tags in a webpage that correlate webpage content to topics from the semantic topic model. In particular, in one or more embodiments, the disclosed systems generate probability values, utilizing one or more neural networks, that map correlations strengths of topics in the semantic topic model to webpage content. Moreover, in one or more embodiments, the disclosed systems utilize the probability values to determine page identification tags to embed within the webpage. Further, the disclosed systems generate an interest map based on the embedded page identification tags to track engagement with the webpage and/or other webpages by one or more user client devices.

### BACKGROUND

Recent years have seen significant improvements in computer hardware and software platforms in embedding page tags within web content to track user interactions with the web content. For example, the widespread use of computing devices and the expanding capabilities of computer systems have resulted in a continuous need to track user engagement with a variety of digital content across various applications and formats. Consequently, due to the vast amount of digital content available, different content tagging systems have been developed to analyze and organize user interactions with digital content. Despite the advancements of existing content tagging systems, current systems frequently exhibit technological limitations that give rise to several shortcomings, particularly in relation to extracting content from webpages and embedding corresponding topic tags that are accurate and useful.

As just suggested, existing content tagging systems are often inaccurate. For example, current content tagging systems attempt to determine page tags for a variety of digital content, such as articles, social media posts, business pages, conversations, reviews, and survey responses. However, these content tagging systems typically generate topic tags without an understanding of the connection level between the topics and the content of the webpage. For example, while some current content tagging systems can identify topics of a webpage by a URL (e.g., by natural language processing (“NLP”) or by keyword frequency), current content tagging systems typically simply tag webpages in response to detecting any connection of web content to a particular topic. Thus, the conventional systems fail to provide any indication of how closely web content relates to a particular topic, which can have impacts on user engagement analysis with web content, in addition to other downstream computing operations such as web search results or website classifications in filters.

Moreover, current content tagging systems are often rigid. For example, current content tagging systems often rely on manual rules for page interaction and journey state management, which do not offer detailed analyses of webpage engagement. The rigidity of current static rule sets of AI-driven NLP models in content tagging systems often limits analyses of webpage engagement to a high-level perspective. Consequently, the analysis of current content tagging systems can be inconsistent, causing traditional content tagging systems to inaccurately map interactions to topics due to a reliance on manual rules or URL/screen name matching rather than a deeper semantic understanding.

In addition, many content tagging systems are inefficient, both in terms of computing resources as well as through client device interactions. For example, in part due to the nature of complex rules required for path determination, current content tagging systems introduce excess processing requirements. In particular, current content tagging systems waste computing resources attempting to connect webpage content via keyword frequency and NLP analysis. To illustrate, many current content tagging systems expend significant processing bandwidth and memory trying to apply webpage content (text, images, structured elements, etc.) to complicated rule structures. Furthermore, as mentioned, current content tagging systems often use URLs or screen names to assign topic tags to a webpage, leading to incorrect correlations. As a result, current content tagging systems require additional processing time to reconcile incorrect matches between webpage content and topics, leading to slower computing performance and the use of additional system resources. Furthermore, existing systems also frequently fail to update tags with changing web content, which also results in inaccurate mappings when certain content is added, changed, or removed.

### BRIEF SUMMARY

This disclosure describes one or more embodiments of methods, non-transitory computer readable media, and systems that solve the foregoing or other problems in addition to providing other benefits. For example, the disclosed systems utilize a semantic topic model in combination with a neural network to embed generated topic tags in a webpage that connect the content of the webpage to topics from the semantic topic model. To illustrate, the disclosed systems utilize the neural network to generate probability values that map the correlation strength of topics from the semantic topic model to webpage content. In some embodiments, the disclosed systems utilize the probability values to determine topic identifications tags to embed within the webpage for tracking engagement. In addition, in some embodiments, the disclosed systems generate an interest map based on the embedded topic identification tags and engagement with the webpage by one or more user client devices.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a dynamic tagging system applying a semantic topic model to generate page identification tags in accordance with one or more embodiments.

FIG. 2 illustrates the dynamic tagging system generating probability values based on webpage content and a semantic topic model in accordance with one or more embodiments.

FIG. 3 illustrates a diagram of a process for utilizing one or more neural networks to generate a hierarchy of page identification tags in accordance with one or more embodiments.

FIG. 4 illustrates a diagram of a process for analyzing client device interactions to generate an interest map associated with a user in accordance with one or more embodiments.

FIG. 5 illustrates a diagram of a process for utilizing a neural network ensemble to generate topic identification tags based on probability values in accordance with one or more embodiments.

FIG. 6 illustrates a diagram of a process for utilizing a user feedback model to train a large language model to establish correlations between webpage content and a semantic topic model in accordance with one or more embodiments.

FIG. 7 illustrates an example system environment in which a dynamic tagging system in accordance with one or more embodiments.

FIG. 8 illustrates a flowchart of a series of acts for embedding program code based on topic identification tags in accordance with one or more embodiments.

FIG. 9 illustrates a block diagram of a computing device in accordance with one or more embodiments.

FIG. 10 illustrates a network environment of a dynamic tagging system in accordance with one or more embodiments.

### DETAILED DESCRIPTION

This disclosure describes embodiments of a dynamic tagging system utilizing a neural network (e.g., large language model) and a semantic topic model to generate and embed program code in webpage content based on topic identification tags that correspond to the webpage content. For example, the dynamic tagging system utilizes a semantic topic model to analyze content from a webpage (text, images, structured content, etc.) and compare the content to categories (themes, topics) to produce a topic distribution. In some embodiments, the dynamic tagging system utilizes the semantic topic model to generate probability values that represent the correlation of webpage content to content categories. Based on the probability values, the dynamic tagging system, by utilizing a neural network, can generate program code to embed within the webpage based on identification tags according to the probability values. In one or more embodiments, by using a neural network in combination with a semantic topic model, the dynamic tagging system embeds program code based on identification tags with corresponding correlation strengths within a webpage to accurately track engagement with the webpage and with specific topics.

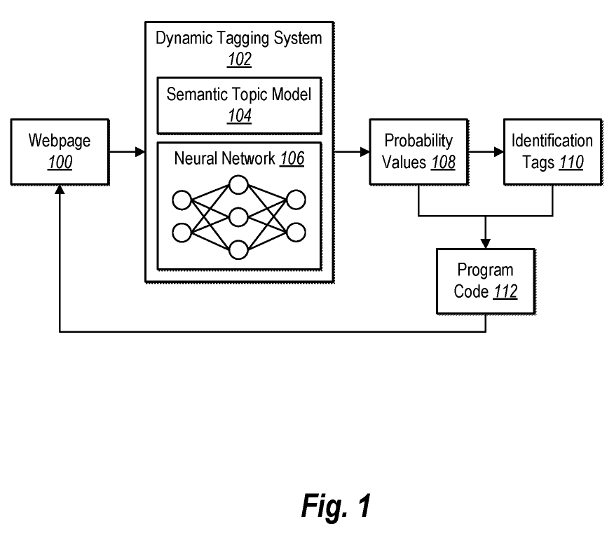

Additional detail regarding the dynamic tagging system 102 will now be provided with reference to the figures. For example, FIG. 1 illustrates a dynamic tagging system applying a semantic topic model to generate page identification tags in accordance with one or more embodiments. As mentioned above, in some embodiments, the dynamic tagging system 102 analyzes content of a webpage 100 to identify relationships between the webpage content and categories defined within a semantic topic model 104. In particular, the dynamic tagging system 102 utilizes a semantic topic model 104 to determine correlations between the content of a webpage 100 and predefined content categories within the semantic topic model 104. In addition, in some embodiments, the generative neural network analyzes a webpage 100 by comparing the content of a web page (text, images, structured content, URL, HTML, etc.) to categories within the semantic topic model 104 (themes, topics related to a specific domain) based on learned attributes of web content in relation to the semantic topic model 104.

For example, a semantic topic model 104 refers to a machine learning-based framework (e.g., neural network trained on a taxonomy of topics) that analyzes text-based content to identify and classify underlying topics. In one or more cases, the semantic topic model 104 uses statistical, probabilistic, or neural network-based methods to determine topic structures from input data. In some embodiments, unlike simple keyword extraction or predefined taxonomies, the semantic topic model 104 understands content relationships by capturing contextual and co-occurrence patterns between words, phrases, and documents. Example implementations of a semantic topic model include, but are not limited to, Latent Dirichlet Allocation (LDA), Latent Semantic Analysis (LSA), Non-Negative Matrix Factorization (NMF), and transformer-based topic modeling approaches. In one or more embodiments described herein, the semantic topic model 104 provides structured topic data that serves as input for a neural network 106 (e.g., an additional neural network), enabling dynamic and context-aware topic tagging of web content.

As shown in FIG. 1, in some cases, the dynamic tagging system 102 uses the analysis of the webpage 100 content performed by semantic topic model 104 to determine one or more page identification tags 110 that match webpage content to content categories via the semantic topic model 104. In some cases, the dynamic tagging system 102, in combination with the neural network 106 (e.g., a large language model), generates one or more page identification tags 110 that correspond to themes of the webpage (e.g., theme tags) and/or topics found within the content of the webpage 100 (e.g., topic identification tags). In various cases, the theme tags represent one or more themes indicated by a hierarchy of topics of the semantic topic model 104, and the topic identification tags represent topics within one or more themes of the semantic topic model 104. In further embodiments, the dynamic tagging system 102, via a neural network 106, generates one or more page identification tags 110 including context tags related to high-level understandings of the content of a webpage independent of the semantic topic model 104 (e.g., utilizing natural language processing).

As further illustrated in FIG. 1, the dynamic tagging system 102, in some embodiments, generates the probability values 108 to indicate correlation strength associated with page identification tags. For example, the dynamic tagging system 102 uses a semantic topic model 104 to evaluate the correlation between webpage content and the topics/themes of one or more page identification tags 110. The dynamic tagging system 102, in some embodiments, provides a percentage associated with each page identification tag to represent the correlation strength of the webpage content to categories within the semantic topic model 104. In various cases, the dynamic tagging system 102 utilizes the semantic topic model 104 to associate particular content items of a webpage 100 (text, images, links, etc.) with categories of the semantic topic model 104.

As shown in FIG. 1, in various embodiments, the dynamic tagging system 102 generates program code 112 based on one or more page identification tags 110 to embed in the webpage 100 to track engagement with the webpage 100. For instance, in certain implementations, the dynamic tagging system 102, via a neural network 106, generates the program code 112 as a script (e.g., in a specific web-based programming language) including one or more page identification tags 110 (e.g., according to a ranking or threshold percentage). Furthermore, in one or more embodiments, the dynamic tagging system 102 generates program code 112 to track engagement with categories associated with the one or more page identification tags (e.g., for themes and/or topics within the semantic topic model 104) by automatically inserting the program code 112 into the webpage 100. In certain implementations, the dynamic tagging system, by utilizing a neural network 106, generates program code 112 to track engagement with context(s), theme(s), and/or topic(s) associated with the content of a webpage 100.

In various embodiments, the dynamic tagging system 102, by utilizing a neural network 106, automatically (or semi-automatically) updates one or more page identification tags 110 and the corresponding program code. The dynamic tagging system 102 can detect when a change has been made in the webpage 100. In some embodiments, the dynamic tagging system 102 determines the webpage 100 content has changed by detecting a change in the HTML code (or other code) of a webpage 100. In response to the detection of a change to the webpage 100, the dynamic tagging system 102 utilizes the semantic topic model 104 to re-analyze correlation between themes/topics of the semantic topic model 104 and the webpage 100. The dynamic tagging system 102, via the neural network 106, uses the corresponding updated probability values as a basis for determining updated page identification tags. The dynamic tagging system 102 can use the updated page identification tags to update the program code 112 and embed the updated program code in the webpage 100, replacing the existing embedded code. As such, the dynamic tagging system 102 automatically updates the embedded code in the webpage 100 for accurately determining engagement for one or more users.

As suggested above, the dynamic tagging system provides several advantages over current page tagging systems. In particular, the dynamic tagging system enhances accuracy over current content tagging systems by generating more accurate page identification tags according to relationships of categories, such as those within the semantic topic model. By generating context, theme, and/or topic tags via one or more neural networks with automated page-tagging, embodiments of the dynamic tagging system accurately map webpage engagement at a granular level. Moreover, the dynamic tagging system dynamically and automatically updates the tags associated with a webpage as content on the webpage changes by leveraging machine-learning integrated with webpage content, ensuring that the tags and corresponding correlation strengths remain accurate over time.

Furthermore, instead of relying on rigid page tagging corresponding to URL or screen name factors as in conventional systems, the dynamic tagging system employs a semantic topic model to flexibly correlate categories with respective correlation strengths. For example, utilizing a semantic topic model trained on topic relationships (e.g., hierarchical categories), the dynamic tagging system generates probability values reflecting correlation strengths between webpage content and semantic categories. These probability values enable the dynamic tagging system to generate more accurate and meaningful correlations. Moreover, rather than relying on rigid and/or overly complex rules as in some conventional systems, the dynamic tagging system flexibly correlates webpage content with semantic categories by generating program code that incorporates the correlation strengths with the corresponding tags into webpage content for improved engagement determination. Relatedly, the dynamic tagging system, by utilizing a neural network, automatically (or semi-automatically) updates embedded page tags, adapting to more accurately reflect evolving content of a webpage.

In addition, the dynamic tagging system introduces significant efficiencies over current content tagging systems. For example, content tagging systems that rely on natural language processing (NLP) and keyword frequency analysis often require post-processing to determine which topics received the most engagement/interactions. In contrast, the dynamic tagging system employs a tagging structure with a plurality of different concepts (e.g., context, theme, topic) combined with probability values to track specific topics most correlated with a webpage. This reduces unnecessary calculations and further optimizes processing time when using engagement metrics to determine interest maps or for other downstream operations. Furthermore, as the dynamic tagging system generates probability values that represent correlation strengths of specific topics, the dynamic tagging system focuses on tracking the most prevalent categories (e.g., via the use of one or more thresholds), further conserving bandwidth and/or memory resources for tagging operations and downstream operations. Indeed, based on these and other efficiencies, the dynamic tagging system processes webpage engagements more quickly and with reduced system overhead.

Moreover, the dynamic tagging system minimizes inefficiencies through reduced client device interactions. Specifically, rather than requiring manual configuration of page tags by URL or screen name as traditional content tagging systems do, the dynamic tagging system enables automatic (or semiautomatic) page tagging due by leveraging a semantic topic model in combination with a neural network. Additionally, in some cases, the dynamic tagging system automatically generates an interest map (e.g., funnel and/or path creation) based on the one or more topic tags embedded in a webpage and their respective relationships. Furthermore, the dynamic tagging system can be refined by updating the parameters of the neural network through user feedback (e.g., via human-in-the-loop validation). Specifically, a client device, in some embodiments, determines indications of reviews for page tags and the correlated content and provides feedback on the accuracy of the correlation. Through these interactions, the dynamic tagging system updates the parameters of the neural network, requiring fewer client device interactions in the future and further enhancing system efficiency.

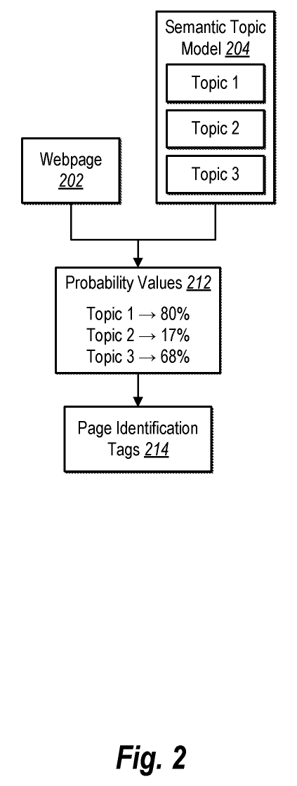

As noted above, the dynamic tagging system 102 can generate probability values 108 representing the correlation strength between webpage content and categories within the semantic topic model. FIG. 2 provides a more detailed example of one such embodiment of the dynamic tagging system 102. In particular, FIG. 2 illustrates a dynamic tagging system generating probability values based on webpage content and a semantic topic model in accordance with one or more embodiments.

As illustrated in FIG. 2, the dynamic tagging system 102 maps content from a webpage 202 to categories within a semantic topic model 204 to generate probability values 212. In some embodiments, the dynamic tagging system 102 utilizes a semantic topic model 204 to generate probability values 212 (e.g., via probability scoring) represented by a percentage that indicates how strongly the content is related to a particular topic or theme in the semantic topic model 204. Alternatively, the dynamic tagging system 102 may generate probability values 212 represented by fractional representations, decimal values, scaled scores, probabilistic values, or other representations. In some embodiments, the dynamic tagging system 102 determines (or estimates) how much of the content of the webpage 202 is related to a certain category (theme and/or topic) defined within the semantic topic model 204. In some cases, the dynamic tagging system 102 utilizes a semantic topic model 204 to identify a correlation strength (e.g., indicated by the probability values 212) between a particular category of the semantic topic model 204 and content of the webpage 202.

In various embodiments, the dynamic tagging system 102 generates a percentage (probability values 212) based on confidence values generated by the semantic topic model 204 when determining that the webpage 202 contains content relating to one or more categories of the semantic topic model 204. In other embodiments, the dynamic tagging system 102 generates a percentage denoting how much content (e.g., a quantitative value) of the webpage 202 is related to the categories. Furthermore, the dynamic tagging system 102 in some embodiments tags specific content items within the webpage 202 with probability values 212 according to how highly those content items relate to categories within the semantic topic model 204. In some embodiments, the dynamic tagging system 102 can determine a certain number of categories to compare to the webpage content (e.g., based on an initial categorization of the webpage 202). In other embodiments, the dynamic tagging system 102 can alternatively or additionally compare each category of the semantic topic model 204 to content of the webpage 202 (e.g., via the semantic topic model). In addition, the dynamic tagging system 102, in some embodiments, generates one or more corresponding probability values 212 for each category in relation to the content of the webpage 202.

As further illustrated in FIG. 2, the dynamic tagging system 102 can generate page identification tags 214 based on probability values 212. In some cases, the dynamic tagging system 102 can generate page identification tags 214 that identify which topics (themes, topics) are most relevant to the webpage 202. In one or more embodiments, the dynamic tagging system 102 generates page identification tags 214 for categories that have probability values 212 (or correlation strengths) over a predetermined threshold value. In some embodiments, the dynamic tagging system 102 generates page identification tags 214 for a predetermined number of categories with the top probability values 212. For example, with a predetermined percentage threshold of 50% (or 0.5 on a normalized scale), the dynamic tagging system 102 may only generate page identification tags for topic 1 and topic 3 as illustrated in FIG. 2. Similarly, with a predetermined numerical threshold of the top three highest probability values, the dynamic tagging system 102, in some embodiments, generates page identification tags for topic 1, topic 2, and topic 3. In various embodiments, the dynamic tagging system 102 provides for other user-defined threshold criteria to guide the generation of page identification tags 214.

In some embodiments, the semantic topic model 204 generates the topics associated with probability values 212 as a distribution of words. In some cases, the dynamic tagging system 102 transforms the topics (e.g., distribution of words) into human-readable page identification tags 214. In one or more embodiments, the dynamic tagging system 102 generates the page identification tags 214 by taking the top N keywords from the topic and utilizes the keywords as the tag. For example, a topic that has the words “sports, team, game” is tagged as “sports,” where “sports” is the top keyword (e.g., occurs most frequently). In these or other cases, the dynamic tagging system 102 generates page identification tags 214 using a predefined mapping of keywords to tag names. In some embodiments, the dynamic tagging system 102 generates page identification tags 214 by utilizing an external knowledge base to label the topics. In one or more embodiments, the dynamic tagging system 102 utilizes a semantic topic model 204, which has been trained on a hierarchical taxonomy of topics. In some cases, a Latent Dirichlet Allocation (“LDA”) processes a corpus of web pages to produce topic vectors, which the dynamic tagging system 102 uses as input features to train the semantic topic model 204 to predict topic tags for new content.

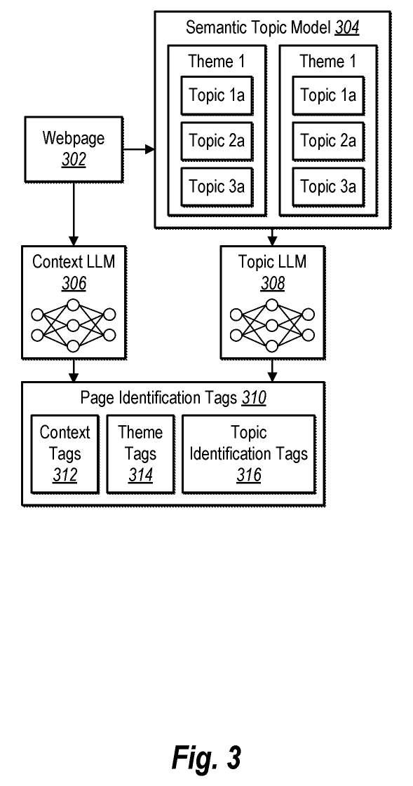

As suggested above, in some embodiments, the dynamic tagging system 102 generates page identification tags 214 according to correlations between content of a webpage 202 and a semantic topic model 204. In some cases, the dynamic tagging system 102 utilizes one or more neural networks to generate page identification tags. FIG. 3 illustrates utilizing one or more neural networks to assign page identification tags to webpage content in accordance with one or more embodiments.

As illustrated in FIG. 3, the dynamic tagging system 102 can use one or more neural networks (e.g., large language models such as a context LLM 306 and a topic LLM 308) to generate page identification tags 310. In some cases, the dynamic tagging system 102 can generate one or more context tags 312 that represent a determined purpose of the content of the webpage. For example, the dynamic tagging system 102 utilizes a context LLM 306 to generate one or more context tags 312 that provide a high-level understanding of the webpage 302 content’s purpose, independent of the topic LLM 308, which generates page identification tags 310 based on the output of the semantic topic model 304. By utilizing a neural network separate from the semantic topic model to determine context information for the webpage 302, the context LLM 306 provides unbiased, high-level insights into the categories associated with webpage content. In other embodiments, the neural network that generates context tags (e.g., context LLM 306) may be the same neural network that generates other page identification tags 310 (theme tags, topic identification tags), or be a neural network that does not generate theme tags or topic identification tags but that also generates page identification tags 310 based on the output of the semantic topic model 304.

Additionally, in various embodiments, the dynamic tagging system 102 generates a plurality of page identification tags 310 that correspond to various categories of content of the webpage 302. For example, a context tag 312 provides a high-level understanding of the purpose of webpage 302 content. For example, a context tag 312 provides one or more indicators related to functions of content of the webpage 302 and/or a description of content of the webpage 302 independent of the semantic topic model 304 (e.g., including terms that may or may not overlap with the topics and themes in the semantic topic model 304). Moreover, in some cases, the dynamic tagging system 102 generates a theme tag 314 that corresponds to broader themes in a categorical hierarchy of the semantic topic model 304. To illustrate, a theme tag 314 classifies a webpage as “educational” or “entertainment,” providing an overarching category that guides further analysis via more specific topic tags. In some cases, the dynamic tagging system 102 generates theme tags 314 that represent the broadest classifications within the categories of the semantic topic model 304, capturing larger categorical themes. Subsequently, in some cases, the dynamic tagging system 102 may generate topic identification tags 316 that represent specific topics discussed on the webpage 302, such as sub-categories of the broader theme categories (e.g., a specific type of educational or entertainment topic). Furthermore, in some embodiments, the dynamic tagging system 102 generates page identification tags 310 to include, or be stored with, additional values, such as correlation strengths to the respective themes/topics.

For example, as illustrated in FIG. 3, the semantic topic model 304, due to training on a taxonomy of topics, may comprise a first theme (e.g., Theme 1) with one or more subtopics (e.g., Topic 1a, Topic 2a, Topic 3a) related to the first theme and a second theme with one or more additional subtopics related to the second theme. The dynamic tagging system 102 may utilize a semantic topic model 304 with a single theme, no theme, or a plurality of themes. Relatedly, the semantic topic model 304 may comprise no themes and only one or more topics. The various levels of page identification tags 310 may allow for flexibility and enhanced insight into the content of webpage 302, supporting a more dynamic understanding of page/screen interactions.

Furthermore, in one or more embodiments, the dynamic tagging system 102 utilizes more than one semantic topic model 304 according to one or more domains or industries. For example, each semantic topic model 304 is trained on a corresponding hierarchy of themes and/or topics based on the specific domain (or industry). Additionally, the dynamic tagging system 102 can train a separate topic LLM 308 for each separate semantic topic model 304 to use in generating page identification tags for webpage content related to the specific industry. In some embodiments, the dynamic tagging system 102 determines which semantic topic model 304 and topic LLM 308 to use based on the context determined utilizing the context LLM 306. Furthermore, in some embodiments, the dynamic tagging system 102 accesses pre-defined ontologies related to a specific industry to generate or otherwise determine one or more semantic topic models 304.

In some embodiments, the dynamic tagging system 102 utilizes a neural network to generate and embed page identification tags 310 in the webpage 302. In one or more cases, the dynamic tagging system 102, via a neural network, assigns one or more page identification tags 310 to the specific content within webpage 302 associated with the page identification tags 310. In various cases, the dynamic tagging system 102 identifies the content of webpage 302 relevant to the topics (e.g., paragraphs, headers, graphics) and embeds the page identification tags 310 in the webpage 302 so as to track user engagement with those topics, as discussed below.

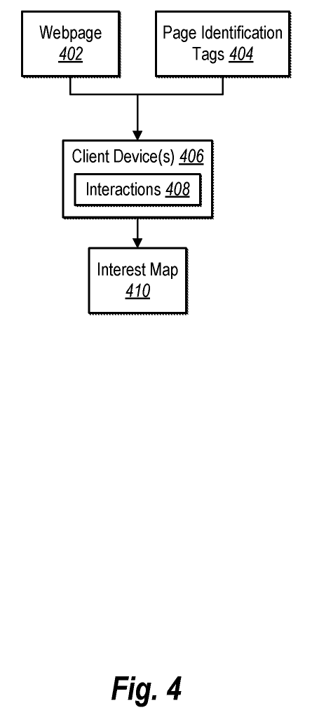

As mentioned, in some cases, the dynamic tagging system 102 generates topic identification tags to use as the basis of a program code embedded in a webpage, which the dynamic tagging system 102 uses to track user engagement with the webpage. In some embodiments, the dynamic tagging system 102 tracks user engagements with one or more webpages to generate an interest map associated with a user, such as for tracking a user journey. FIG. 4 illustrates analyzing client device interactions to generate an interest map associated with a user in accordance with one or more embodiments.

In some embodiments, the dynamic tagging system 102 tracks user engagements in one or more webpages 402 to create an interest map 410 associated with a user. For example, the dynamic tagging system 102 monitors and records user interactions 408 with one or more webpages (e.g., webpage 402) and generates a corresponding interest map 410 that constructs an outline of user interests and preferences by mapping specific themes or topics to a user identifier for the user. Specifically, in some cases, the dynamic tagging system 102 tracks user interactions 408 associated with a user with one or more webpages utilizing one or more client devices 406 and generates mappings between the user and the interactions with the webpage(s) for the one or more client devices 406. To illustrate, the dynamic tagging system 102 detects interactions such as, but not limited to, visits, clicks, scrolls, view times, or other interactions with the webpage 402. Additionally, in some embodiments, the dynamic tagging system 102 detects interactions with individual elements (e.g., text, images, links) within the webpage 402.

In response to detecting interactions with the webpage 402 (e.g., based on the mappings between the user and the corresponding interactions), the dynamic tagging system 102 generates the interest map 410 to indicate possible interests of the user with one or more themes and/or topics associated with the webpage 402. In one or more embodiments, the dynamic tagging system 102 generates the interest map 410 based on interactions 408 associated with a single client device 406 or based on interactions associated with multiple client devices associated with a user. For example, a user account of the user may be associated with a single client device or a plurality of client devices. Accordingly, in some embodiments, the dynamic tagging system 102 generates the interest map 410 in connection with the user account regardless of the number of client devices. Furthermore, in some embodiments, the dynamic tagging system 102 tracks interactions for different user accounts on a single client device to generate separate interest maps for the separate user accounts.

In various embodiments, the dynamic tagging system 102 utilizes program code embedded in the webpage 402 to generate the interest map 410. In some cases, the program code is based on page identification tags 404 that serve as markers or identifiers for the webpage 402 as a whole or for specific elements or sections of a webpage 402. In some cases, when a user interacts with a webpage 402, the dynamic tagging system 102 associates user actions with particular content or features of the webpage 402. In some cases, this process ensures that the tracked user interactions 408 are directly linked to the webpage 402 as a whole and/or to individual elements of the webpage 402, enabling the dynamic tagging system 102 to collect data with high relevance and accuracy.

In one or more embodiments, based on the tracked user interactions 408 with the webpage 402 and the page identification tags 404 corresponding to the program code embedded in the webpage 402, the dynamic tagging system 102 generates the interest map 410 for a user. In one or more embodiments, the interest map 410 reflects a structured representation of user preferences in specific themes and/or topics, derived from their behavior across one or more webpages. Furthermore, in some cases, the interest map 410 is dynamic and evolves based on continuous input from new user interactions. As such, in various embodiments, the dynamic tagging system 102 generates the interest map 410 to provide a dynamic and personalized view of user interests over time based on the user’s interactions with various webpages according to the page identification tags 404 associated with the webpages and/or elements within the webpages.

Additionally, as mentioned, the dynamic tagging system 102 can utilize user engagements to track a user journey by tracking interactions that impact journey states (e.g., start, continuation, exit, pause, or end) based on the specific page identification tags assigned to the web content with which the user interacts. Furthermore, the dynamic tagging system 102 can also utilize the information from the interest map 410 and/or journey state information to perform more precise funnel analysis on web content. For example, the dynamic tagging system 102 provides in-depth analysis of user engagement with specific themes or topics for building or modifying funnel configurations on webpages, rather than simply analyzing based on URLs or screen names, while also delivering relevant, personalized experiences to users over time.

In particular embodiments, the dynamic tagging system 102 generates the interest map 410 by incorporating correlation strengths associated with the identification tags 404. For example, in one or more embodiments, the probability values include or are otherwise associated with correlation strengths of the content of the webpage 402 and semantic topic model categories. Thus, the probability values allow the dynamic tagging system 102 to evaluate how closely the user interactions 408 align with corresponding themes or topics.

In various embodiments, as mentioned, the program code associates page identification tags 404 with specific webpage content items. For example, if a user interacts with sections of a webpage 402 tagged with high-probability correlations (probability values) to a particular topic, such as “technology trends” or “outdoor gear,” the dynamic tagging system 102 stores information about the topic in the interest map 410. Furthermore, in one or more embodiments, the dynamic tagging system 102 uses correlation strengths associated with the page identification tags 404 to store information about a strength of user association with these topics in the interest map 410. As an example, interactions with elements of a webpage having a page identification tag with a high correlation strength (e.g., >80%) cause a stronger association to the user in the interest map 410 than interactions with elements of a webpage having a page identification tag with a low correlation strength (e.g., <20%). The correlation strengths also have similar impacts on the interest map 410 for whole webpages tagged with specific page identification tags. By combining structural mapping of webpage content with page identification tags 404, the dynamic tagging system 102 constructs a robust and adaptive interest map 410 for users based on their interactions with the web content.

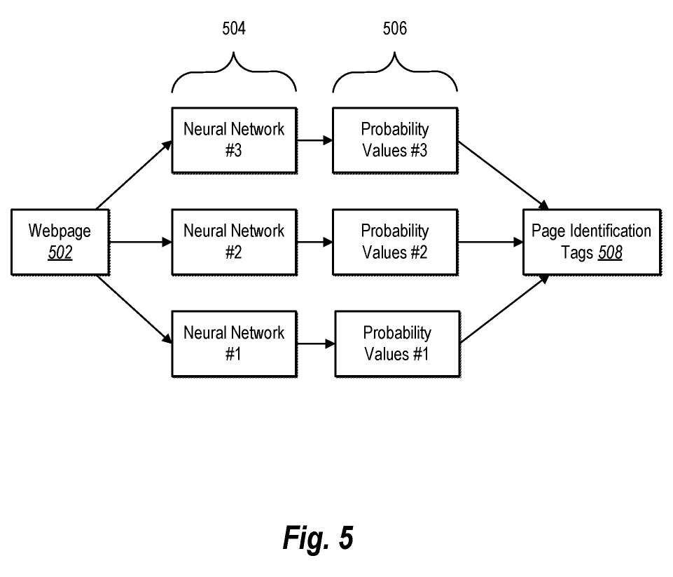

As suggested above, in some embodiments, the dynamic tagging system 102 generates page identification tags based on webpage content. In some cases, the dynamic tagging system 102 generates page identification tags utilizing one or more neural networks. FIG. 5 illustrates utilizing a neural network ensemble to generate topic identification tags based on probability values in accordance with one or more embodiments.

As shown in FIG. 5, the dynamic tagging system 102 can utilize a neural network ensemble 504 (more than one neural network) to generate page identification tags 508 (e.g., theme tags, topic identification tags). In some embodiments, the dynamic tagging system 102 can utilize one or more neural networks (or semantic topic models) individually trained on a taxonomy of topics to generate page identification tags 508. In various cases, each neural network in a neural network ensemble 504 analyzes the semantic relationships between content of a webpage 502 and categories recognized by the semantic topic model. In one or more embodiments, the dynamic tagging system 102 utilizes an ensemble approach, which combines the outputs of multiple neural networks, to provide a robust mechanism for tagging content by reducing the influence of errors or biases that might arise from utilizing a single neural network. Accordingly, in various embodiments, the neural network ensemble 504 includes a plurality of different types of neural networks, each of which may be more accurate for certain types of content (e.g., images, videos, structured text, natural language text) than others.

As further shown, in some embodiments, the dynamic tagging system 102 utilizes the neural network ensemble 504 to generate sets of probability values 506 for each identified piece of content of a webpage 502. Specifically, the dynamic tagging system 102 utilizes a plurality of neural networks in the neural network ensemble 504 to assign each extracted piece of content one or more corresponding categories from the semantic topic model based on the sets of probability values 506. In one or more additional embodiments, the sets of probability values 506 represent the correlation strength between specific web content and the predefined categories in the semantic topic model based on the respective neural networks (e.g., based on confidence values generated by the neural networks). By employing a neural network ensemble 504, the dynamic tagging system 102 effectively generates several independent assessments of correlations between webpage content and categories of the semantic topic model and uses the separate assessments to determine the page identification tags 508 for the webpage 502. This redundancy adds a layer of validation to the tagging process as executed by the dynamic tagging system 102 by comparing or averaging the results from the separate neural networks in the neural network ensemble 504. In these or other cases, the dynamic tagging system 102 may apply a neural network ensemble 504 (or a single neural network or semantic topic model) to analyze content of a PDF, document, or other piece of informative content.

As further depicted in FIG. 5, the dynamic tagging system 102, in some embodiments, determines an average probability value for each category by aggregating the outputs from all neural networks in the ensemble (the sets of probability values 506). In various embodiments, for each topic or theme within the semantic topic model, the dynamic tagging system 102 determines an average probability value based on the sets of probability values 506 generated by the neural networks in the neural network ensemble 504. The dynamic tagging system 102 uses these averaged values to represent a consensus view of the correlation strength and form the basis for generating page identification tags 508. Furthermore, in some embodiments, the dynamic tagging system 102 selects a median probability value in a set of probability values to determine a page identification tag for the corresponding theme or topic.

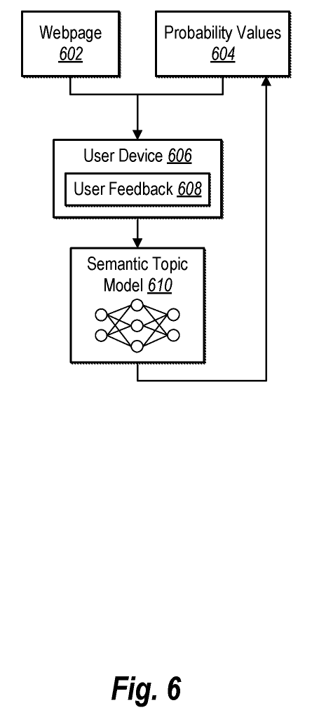

In some embodiments, the dynamic tagging system 102 detects user engagement with a webpage that has program code embedded in the webpage. FIG. 6 illustrates utilizing a user feedback model to train a large language model to establish correlations between webpage content and a semantic topic model in accordance with one or more embodiments.

As illustrated in FIG. 6, the dynamic tagging system 102, in one or more embodiments, utilizes a user feedback loop to further train the functionality of a the semantic topic model 610. In some cases, this feedback loop allows the users to directly improve the accuracy of the dynamic tagging system 102 by providing input on the probability values 604 (or alternatively to labels generated by the semantic topic model 610). Additionally, in various embodiments, the dynamic tagging system 102 provides an interface on a client device 606 for a user to review the generated semantic topic model 610 output (probability values 604) and the associated content (content of webpage 602). Through the client device 606, in some embodiments, a user can view the content of a webpage 602 alongside the categories (themes, topics) within the semantic topic model assigned to that content. The interface on the client device 606 also, in some cases, displays the associated probability values 604 that indicate the correlation strength between the content of webpage 602 and each assigned category within the semantic topic model 610.

In various cases, a user identifies inaccuracies—such as incorrect tags or inaccurate probability values 604—and provides such feedback through a client device 606. For example, a user can flag a category as irrelevant or suggest an adjustment to the probability values 604 associated with an identified category. Upon receiving feedback indicating an error corresponding to a misclassified tag, in some cases, the dynamic tagging system 102 adjusts the probability values 604 (or labels) associated with the flagged content. The dynamic tagging system 102 applies these corrections to improve the current representation of the webpage semantic relationships (probability values 604) by using the corrections as ground truth values to compare to the outputs of the semantic topic model 610 (e.g., for comparing ground truth correlation strengths to the probability values or ground truth labels to a set of labels determined by the semantic topic model 610). Additionally, in some cases, the dynamic tagging system 102 updates parameters of the semantic topic model 610 according to the user feedback 608. Furthermore, in one or more embodiments, the dynamic tagging system 102 updates parameters of the semantic topic model 610 in response to changes to the taxonomy of topics used to train the semantic topic model (e.g., by refining or retraining the semantic topic model 610 with a new hierarchy of themes and topics). Updating the semantic topic model parameters enables the semantic topic model 610 to reduce the likelihood of similar errors occurring in the future, improving the accuracy and efficiency of the semantic topic model 610 and the dynamic tagging system 102.

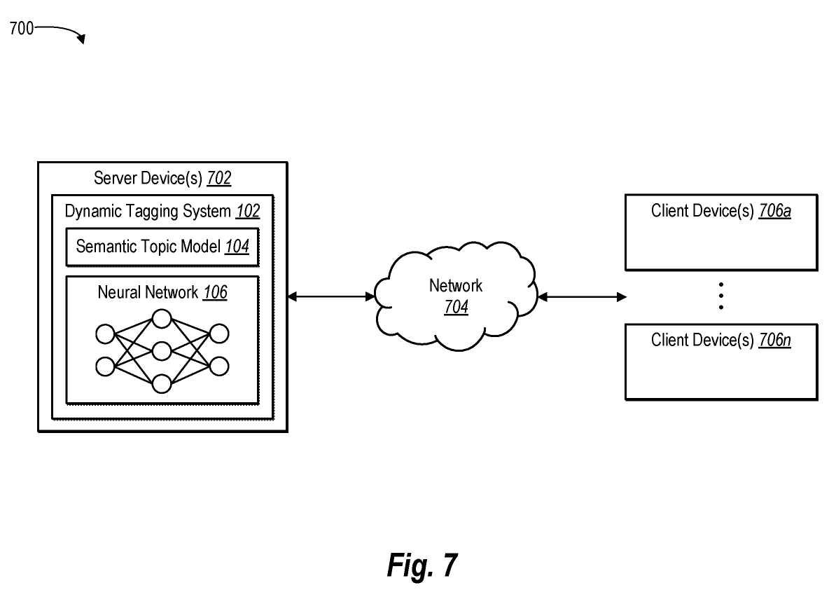

As discussed above, in some embodiments, the dynamic tagging system 102, via a neural network, embeds program code based on page identification tags generated by a neural network. FIG. 7 illustrates a block diagram of a system environment 700 (“environment”) in which a dynamic tagging system 102, a semantic topic model 104, and a neural network 106 (e.g., large language model) operate in accordance with one or more embodiments. As illustrated in FIG. 7, the system environment 700 includes server device(s) 702, recipient client device(s) 706a-706n, and network 704, where the server device(s) 702 include the dynamic tagging system 102.

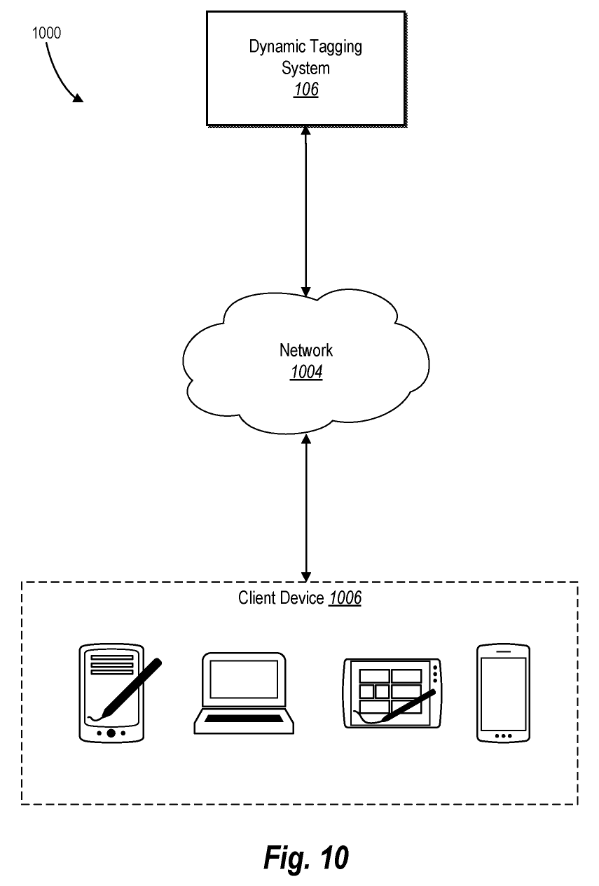

As shown in FIG. 7, the dynamic tagging system 102 comprises the semantic topic model 104 and the neural network 106. The server device(s) 702 and the recipient client device(s) 706a-706n are communicatively coupled with each other either directly or indirectly through the network 704 (as discussed in greater detail below in relation to FIG. 10). Additionally, in some embodiments, the server device(s) 702, the recipient client device(s) 706a-706n, and the network 704 include a variety of computing devices (including one or more computing devices as discussed in greater detail with relation to FIG. 10).

In some embodiments, the recipient client device(s) 706a-706n communicate with server device(s) 702 over the network 704. As described below, the server device(s) 702 can enable the various functions, features, processes, methods, and systems described herein using, for example, the dynamic tagging system 102. As shown in FIG. 7, the dynamic tagging system 102, in combination with the semantic topic model 104 and the neural network 106, comprises computer executable instructions that, when executed by a processor of the server device(s) 702, perform certain actions described with reference to FIGS. 1-6 and FIGS. 8-10. Additionally, or alternatively, in some embodiments, the server device(s) 702 coordinate with the recipient client device(s) 706a-706n to perform or provide the various functions, features, processes, methods, and systems described in more detail below. Although FIG. 7 illustrates a particular arrangement of the server device(s) 702, the recipient client device(s) 706a-706n, and the network 704, various additional arrangements are possible.

Generally, the recipient client device(s) 706a-706n may be any one of various types of client devices. For example, the recipient client device(s) 706a-706n may be mobile devices (e.g., a smart phone, tablet), laptops, desktops, or any other type of computing devices, such as those described below with reference to FIG. 10. Additionally, the server device(s) 702 may include one or more computing devices, including those explained below with reference to FIG. 10. The server device(s) 702 and the recipient client device(s) 706a-706n may communicate using any communication platforms and technologies suitable for transporting data and/or communication signals, including the examples described below with reference to FIG. 10.

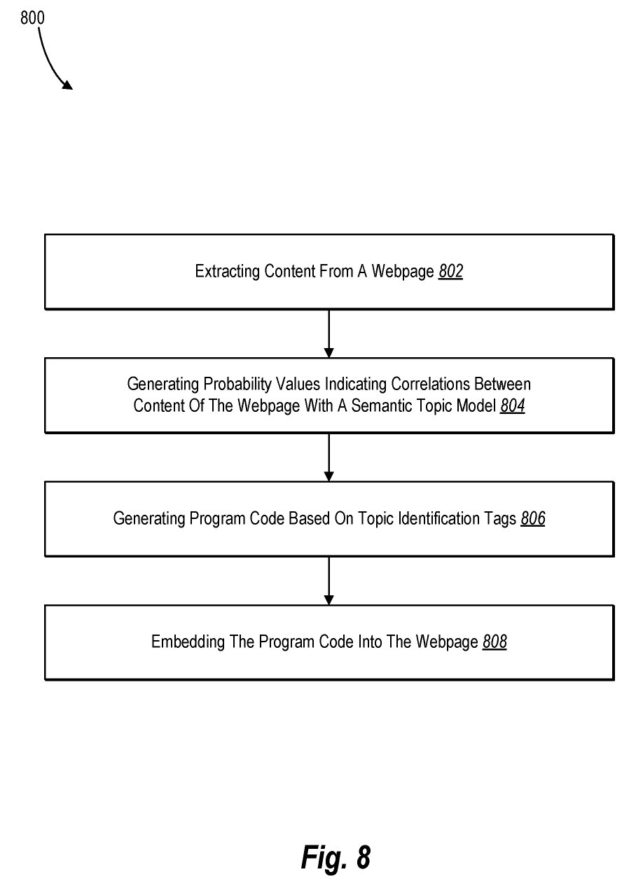

Turning now to FIG. 8, this figure illustrates a flowchart of a series of acts 800 for generating and embedding program code in webpage content based on topic identification tags that correspond to the webpage content in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer readable storage medium can comprise instructions that, when executed by one or more processors, cause a computing device to perform the acts depicted in FIG. 8. In still further embodiments, a system can perform the acts of FIG. 8.

As shown in FIG. 8, the acts 800 include an act 802 of extracting content from a webpage. In particular, in some embodiments, the act 802 includes extracting, by at least one processor and from a webpage, content comprising text, metadata, and structured elements of the webpage. As further shown in FIG. 8, the acts 800 include an act 804 of generating probability values indicating correlations between content of the webpage with a semantic topic model. In particular, in some embodiments, the act 804 includes generating, using a semantic topic model trained on a plurality of predefined topics, one or more probability values indicating one or more correlations between the content of the webpage with one or more topics from the plurality of predefined topics in the semantic topic model.

As further shown in FIG. 8, the acts 800 include an act 806 of generating program code based on topic identification tags. In particular, in some embodiments, the act 806 includes generating, by the at least one processor, a program code configured to collect data about interactions with the webpage based on one or more topic identification tags according to the one or more probability values. As also shown in FIG. 8, the acts 800 include an act 808 of embedding the program code into the webpage. In particular, the act 808 includes embedding, by the at least one processor, the program code based on the one or more topic identification tags into the webpage.

In addition to the acts 802-808, the acts 800 may include additions or variations. In certain implementations, for instance, the series of acts 800 includes generating the program code by determining one or more topic identification tags relative to a predetermined probability value threshold. Furthermore in some cases, the series of acts 800 includes generating the program code based on the one or more probability values for the one or more topic identification tags relative to the predetermined probability value threshold.

In some cases, the series of acts 800 further includes generating the program code by determining a ranking of the one or more topic identification tags based on associated probability values. Additionally, in one or more embodiments, the series of acts 800 and generating the program code based on the ranking of the one or more topic identification tags according to a threshold number of topic identification tags.

Further, in one or more embodiments, the series of acts 800 includes determining one or more interactions with the webpage by one or more client devices associated with a user. Furthermore, in one or more embodiments, the series of acts 800 includes generating a mapping between the one or more interactions with the webpage and the user associated with the one or more client devices. Additionally, in some cases, the series of acts 800 includes generating an interest map for the user based on the mapping and the one or more topic identification tags.

Moreover, in one or more embodiments, the series of acts 800 includes generating the program code by generating the program code based on a context tag representing a determined purpose of the content of the webpage and one or more theme tags representing one or more themes indicated by a hierarchy of topics in the semantic topic model.

In some embodiments, the series of acts 800 includes generating the one or more probability values by generating a first set of probability values utilizing a neural network in an ensemble model. Further, in one or more embodiments, the series of acts 800 includes generating a second set of probability values utilizing an additional neural network in the ensemble model. Moreover, in some cases, the series of acts 800 includes determining the one or more probability values by combining the first set of probability values and the second set of probability values.

Moreover, in one or more embodiments, the series of acts 800 includes generating the one or more probability values by generating, utilizing the semantic topic model, a first probability value that the content of the webpage corresponds to a first topic of the plurality of predefined topics of the semantic topic model. Additionally, in various embodiments, the series of acts 800 includes generating, utilizing the semantic topic model, a second probability value that the content of the webpage corresponds to a second topic of the plurality of predefined topics of the semantic topic model.

Moreover, in some embodiments, the series of acts 800 includes providing, for display for display to one or more client devices, the one or more topic identification tags with the content of the webpage. In addition, in various cases, the series of acts 800 includes determining, from responses by the one or more client devices, one or more indications of one or more misclassified tags from the one or more topic identification tags in relation to the content of the webpage. Additionally, in one or more embodiments, the series of acts 800 includes modifying parameters of the semantic topic model to correct the one or more misclassified tags in connection with the content of the webpage.

Moreover, in one or more embodiments, the series of acts includes generating the program code by generating, utilizing the semantic topic model, one or more theme tags representing one or more themes indicated by a hierarchy of topics of the semantic topic model. Furthermore, in some embodiments, the series of acts 800 includes generating, utilizing the semantic topic model , the one or more topic identification tags. Furthermore, in various cases, the series of acts 800 includes generating, via a neural network, the program code based on a combination of the one or more theme tags and the one or more topic identification tags.

Furthermore, in one or more embodiments, the series of acts 800 includes generating the one or more probability values by determining a correlation strength between the content of the webpage with a topic of the plurality of predefined topics based on the one or more probability values. Additionally, in some cases, the series of acts 800 includes generating the program code based on the correlation strength.

Moreover, in some embodiments, the series of acts 800 includes generating the program code by generating the program code based on a context tag representing a determined purpose of the content of the webpage and one or more theme tags representing one or more themes indicated by a hierarchy of topics of the semantic topic model.

Furthermore, in one or more embodiments, the series of acts 800 includes generating the program by determining one or more interactions with the webpage by one or more client devices associated with a user. Additionally, in some cases, the series of acts 800 includes generating a mapping between the one or more interactions and the user associated with the one or more client devices. Further, in various embodiments, the series of acts 800 includes generating an interest map for the user based on the one or more topic identification tags embedded in the webpage and the mapping.

Moreover, in one or more embodiments, the series of acts 800 includes generating the interest map for the user by detecting one or more additional interactions with an additional webpage by the one or more client devices associated with the user. Additionally, in some embodiments, the series of acts 800 includes determining one or more additional topic identification tags for one or more additional topics corresponding to content of the additional webpage. Further, in various embodiments, the series of acts 800 includes generating, utilizing the one or more topic identification tags and the one or more additional interactions, the interest map by combining one or more correlation strengths between the content of the webpage with the one or more topics and one or more additional correlation strengths between the content of the additional webpage with the one or more additional topics.

Moreover, in one or more embodiments, the series of acts 800 includes embedding the program code by embedding the one or more topic identification tags into the webpage.

Additionally, in one or more embodiments, the series of acts 800 includes detecting a change in a HyperText Markup Language (HTML) of the webpage. In addition, in various cases, the series of acts 800 involves generating, responsive to the detected change in the HTML, one or more updated probability values indicating one or more correlations between the content of the webpage with one or more topics from the plurality of predefined topics of the semantic topic model. Furthermore, the series of acts 800 includes generating an updated program code based on one or more updated topic identification tags according to the one or more updated probability values.

Moreover, in various embodiments, the series of acts 800 includes embedding the program code into the webpage by generating a script including the program code for inserting into a webpage. Additionally, the series of acts 800 includes embedding the script into a HyperText Markup Language (HTML) of the webpage.

Furthermore, in one or more cases, the series of acts 800 includes determining one or more correlation strengths between the content of the webpage with the one or more topics based on the one or more probability values. In addition, the series of acts 800 involves generating the one or more topic identification tags in response to determining that the one or more correlation strengths meet a predetermined threshold. Further, the series of acts 800 includes generating the program code based on the one or more correlation strengths for the one or more topic identification tags meeting the predetermined threshold.

In some cases, the series of acts 800 includes generating a mapping between a user and one or more interactions with the webpage by a client device associated with the user. Further, the series of acts 800 involves generating an interest map for the user based on the one or more topic identification tags embedded in the webpage and the mapping.

Embodiments of the present disclosure may comprise or utilize a special-purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

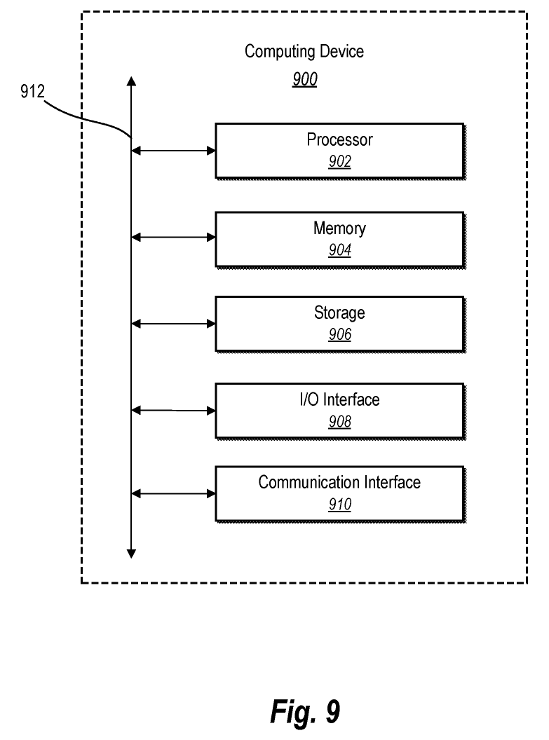

FIG. 9 illustrates, in block diagram form, an example computing device 900 (e.g., the computing device 900, the client device(s) 706a-706n, and/or the server device(s) 702) that may be configured to perform one or more of the processes described above. As shown by FIG. 9, the computing device can comprise a processor(s) 902, memory 904, a storage device 906, an I/O interface 908, and a communication interface 910.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them. The computing device 900 includes memory 904, which is coupled to the processor(s) 902. The memory 904 may be used for storing data, metadata, and programs for execution by the processor(s). The memory 904 may include one or more of volatile and non-volatile memories. The memory 904 may be internal or distributed memory. The computing device 900 includes a storage device 906 includes storage for storing data or instructions. As an example, and not by way of limitation, storage device 906 can comprise a non-transitory storage medium described above. The computing device 900 also includes one or more input or output (“I/O”) devices/interfaces 908, which are provided to allow a user to provide input to (such as user strokes), receive output from, and otherwise transfer data to and from the computing device 900. These I/O devices/interfaces 908 may include a mouse, keypad or a keyboard, a touch screen, camera, optical scanner, network interface, modem, other known I/O devices or a combination of such I/O devices/interfaces 908.

The computing device 900 can further include a communication interface 910. The communication interface 910 can include hardware, software, or both. The communication interface 910 can provide one or more interfaces for communication (such as, for example, packet-based communication) between the computing device and one or more other computing devices (e.g., computing device 900) or one or more networks. The computing device 900 can further include a bus 912. The bus 912 can comprise hardware, software, or both that couples components of computing device 900 to each other.

FIG. 10 illustrates an example network environment 1000 of the dynamic tagging system 102. Network environment 1000 includes the dynamic tagging system 102 and the client device 1006 connected to each other by a network 1004. Although FIG. 10 illustrates a particular arrangement of client device 1006, dynamic tagging system 102, and network 1004, this disclosure contemplates any suitable arrangement of client device 1006, dynamic tagging system 102, and network 1004. As an example, and not by way of limitation, two or more client device(s) 1006 and the dynamic tagging system 102 may be connected to each other directly, bypassing the network 1004. As another example, two or more client device(s) 1006 and the dynamic tagging system 102 may be physically or logically co-located with each other in whole, or in part. Moreover, although FIG. 10 illustrates a particular number of the client device 1006 devices, dynamic tagging system 102 devices, and network 1004, this disclosure contemplates any suitable number of the client device 1006 , dynamic tagging system 102 devices, and network 1004. As an example, and not by way of limitation, network environment 1000 may include multiple of the client device(s) 1006, dynamic tagging system 102 devices, and network 1004.

This disclosure contemplates any suitable network for the network 1004. As an example and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more of the network 1004.

Links may connect the client device 1006, and the dynamic tagging system 102 to the network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”)), wireless (such as for example Wi-Fi or Worldwide Interoperability for Microwave Access (“WiMAX”)), or optical (such as for example Synchronous Optical Network (SONET) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by the client device 1006. As an example, and not by way of limitation, the client device 1006 may include any of the computing devices discussed above in relation to FIG. 9. The client device 1006 may enable a network user at the client device 1006 to access the network 1004.

In particular embodiments, the client device 1006 may include a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server, or a server associated with a third-party system), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the dynamic tagging system 102 may include a variety of servers, sub-systems, programs, modules, logs, and data stores. In particular embodiments, the dynamic tagging system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The dynamic tagging system 102 may also include suitable components such as network interfaces, security mechanisms, load balancers, failover servers, management-and-network-operations consoles, other suitable components, or any suitable combination thereof.

In particular embodiments, the dynamic tagging system 102 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
extracting, by at least one processor and from a webpage, content comprising text, metadata, and structured elements of the webpage;
generating, using a semantic topic model trained on a plurality of predefined topics, one or more probability values indicating one or more correlations between the content of the webpage with one or more topics from the plurality of predefined topics of the semantic topic model;
generating, by the at least one processor, a program code configured to collect data about interactions with the webpage based on one or more topic identification tags according to the one or more probability values; and
embedding, by the at least one processor, the program code based on the one or more topic identification tags into the webpage.

2. The method of claim 1, wherein generating the program code comprises:
determining one or more topic identification tags relative to a predetermined probability value threshold; and
generating the program code based on the one or more probability values for the one or more topic identification tags relative to the predetermined probability value threshold.

3. The method of claim 1, wherein generating the program code comprises:
determining a ranking of the one or more topic identification tags based on associated probability values; and
generating the program code based on the ranking of the one or more topic identification tags according to a threshold number of topic identification tags.

4. The method of claim 1, further comprising:
determining one or more interactions with the webpage by one or more client devices associated with a user;
generating a mapping between the one or more interactions with the webpage and the user associated with the one or more client devices; and
generating an interest map for the user based on the mapping and the one or more topic identification tags.

5. The method of claim 1, wherein generating the program code further comprises generating the program code based on a context tag representing a determined purpose of the content of the webpage and one or more theme tags representing one or more themes indicated by a hierarchy of topics of the semantic topic model.

6. The method of claim 1, wherein generating the one or more probability values comprises:
generating a first set of probability values utilizing a neural network in an ensemble model;
generating a second set of probability values utilizing an additional neural network in the ensemble model; and
determining the one or more probability values by combining the first set of probability values and the second set of probability values.

7. The method of claim 1, wherein generating the one or more probability values comprises:
generating, utilizing the semantic topic model, a first probability value that the content of the webpage corresponds to a first topic of the plurality of predefined topics of the semantic topic model; and
generating, utilizing the semantic topic model, a second probability value that the content of the webpage corresponds to a second topic of the plurality of predefined topics of the semantic topic model.

8. A system comprising:
at least one processor; and
at least one non-transitory computer readable storage medium comprising instructions that, when executed by the at least one processor, cause the system to:
extract, from a webpage, content comprising text, metadata, and structured elements of the webpage;
generate, using a semantic topic model including a plurality of predefined topics, one or more probability values indicating one or more correlations between the content of the webpage with one or more topics from the plurality of predefined topics of the semantic topic model;
generate, by the at least one processor, a program code configured to collect data about interactions with the webpage based on one or more topic identification tags according to the one or more probability values; and
embed, by the at least one processor, the program code based on the one or more topic identification tags into the webpage.

9. The system of claim 8, further comprising instructions that, when executed by the at least one processor, cause the system to:
provide, for display to one or more client devices, the one or more topic identification tags with the content of the webpage;
determine, from responses by the one or more client devices, one or more indications of one or more misclassified tags from the one or more topic identification tags in relation to the content of the webpage; and
modify parameters of the semantic topic model to correct the one or more misclassified tags in connection with the content of the webpage.

10. The system of claim 9, wherein generating the program code further comprises:
generating, utilizing the semantic topic model, one or more theme tags representing one or more themes indicated by a hierarchy of topics of the semantic topic model;
generating, utilizing the semantic topic model, the one or more topic identification tags; and
generating, via a neural network, the program code based on a combination of the one or more theme tags and the one or more topic identification tags.

11. The system of claim 8, wherein the instructions that cause the system to generate the one or more probability values comprise:
determining a correlation strength between the content of the webpage with a topic of the plurality of predefined topics based on the one or more probability values; and
generating the program code based on the correlation strength.

12. The system of claim 8, wherein generating the program code further comprises generating the program code based on a context tag representing a determined purpose of the content of the webpage and one or more theme tags representing one or more themes indicated by a hierarchy of topics of the semantic topic model.

13. The system of claim 8, further comprising instructions that, when executed by the at least one processor, cause the system to:
determine one or more interactions with the webpage by one or more client devices associated with a user;
generate a mapping between the one or more interactions and the user associated with the one or more client devices; and
generate an interest map for the user based on the one or more topic identification tags embedded in the webpage and the mapping.

14. The system of claim 13, further comprising instructions that, when executed by the at least one processor, cause the system to generate the interest map for the user by:
detecting one or more additional interactions with an additional webpage by the one or more client devices associated with the user;
determining one or more additional topic identification tags for one or more additional topics corresponding to content of the additional webpage; and
generating, utilizing the one or more topic identification tags and the one or more additional interactions, the interest map by combining one or more correlation strengths between the content of the webpage with the one or more topics and one or more additional correlation strengths between the content of the additional webpage with the one or more additional topics.

15. The system of claim 8, further comprising instructions that, when executed by the at least one processor, cause the system to embed the program code by embedding the one or more topic identification tags into the webpage.

16. A non-transitory computer-readable medium storing instructions that, when executed by at least one processor, cause a computing device to:
extract, from a webpage, content comprising text, metadata, and structured elements of the webpage;
generate, using a semantic topic model trained on a plurality of predefined topics, one or more probability values indicating one or more correlations between the content of the webpage with one or more topics from the plurality of predefined topics of the semantic topic model;
generate, by the at least one processor, a program code configured to collect data about interactions with the webpage based on one or more topic identification tags according to the one or more probability values; and
embed, by the at least one processor, the program code based on the one or more topic identification tags into the webpage.

17. The non-transitory computer-readable medium of claim 16, further comprising instructions that, when executed by the at least one processor, cause the computing device to:
detect a change in a HyperText Markup Language (HTML) of the webpage;
generate, responsive to the detected change in the HTML, one or more updated probability values indicating one or more correlations between the content of the webpage with one or more topics from the plurality of predefined topics of the semantic topic model; and
generate an updated program code based on one or more updated topic identification tags according to the one or more updated probability values.

18. The non-transitory computer-readable medium of claim 16, further comprising instructions that, when executed by the at least one processor, cause the computing device to embed the program code into the webpage by:
generating a script including the program code for inserting into a webpage; and
embedding the script into a HyperText Markup Language (HTML) of the webpage.

19. The non-transitory computer-readable medium of claim 16, wherein generating one or more probability values further comprises instructions that, when executed by the at least one processor, cause the computing device to:
determine one or more correlation strengths between the content of the webpage with the one or more topics based on the one or more probability values;
generate the one or more topic identification tags in response to determining that the one or more correlation strengths meet a predetermined threshold; and
generate the program code based on the one or more correlation strengths for the one or more topic identification tags meeting the predetermined threshold.

20. The non-transitory computer-readable medium of claim 16, further comprising instructions that, when executed by the at least one processor, cause the computing device to:
generate a mapping between a user and one or more interactions with the webpage by a client device associated with the user; and
generate an interest map for the user based on the one or more topic identification tags embedded in the webpage and the mapping.
